(19) United States
(12) Patent Application Publication
(10) Pub. No.: US 2011/0078872 A1
(43) Pub. Date: Apr. 7, 2011

(54) UPRIGHT VACUUM CLEANER WITH FRAMEWORK SUPPORT

(76) Inventor: James Todd Crouch, Danville, KY (US)

(21) Appl. No.: 12/574,373

(22) Filed: Oct. 6, 2009

(51) Int. Cl. A47L 9/00; B23P 17/04

(52) U.S. Cl. 15/347; 29/592

(57) ABSTRACT

A floor care appliance is provided including a nozzle assembly having a suction inlet and a mechanical housing including a control handle. A dirt collection vessel is held in the mechanical housing. A suction generator is held in one of the nozzle assembly and the mechanical housing. A universal framework receives and holds the mechanical housing and pivotally connects the mechanical housing to the nozzle assembly. In addition a model line of floor care appliances is provided. Further a method is provided for providing a product line of floor care appliance models while reducing production and tooling costs.

### TECHNICAL FIELD AND INDUSTRIAL APPLICABILITY OF THE INVENTION

The present invention relates generally to the floor care equipment field and, more particularly, to a floor care appliance incorporating a novel framework as well as to a model line of floor care appliances all incorporating the same model framework.

### BACKGROUND OF THE INVENTION

Floor care appliances such as extractors and upright vacuum cleaners have long been known in the art. During the commercial development of these appliances various design permutations have been made and successfully marketed. Thus, consumers have been given choices in their vacuum cleaners and different consumers favor different operating features.

In an effort to expand market share, floor care appliance manufacturers have found it necessary to offer different models incorporating different operating features as this is the only way those manufacturers can have their products appeal to a broader customer base. As a result, upright vacuum cleaner manufacturers typically offer models including a dirt collection vessel of one of or more the following general types: a filter bag, a dirt cup or a cyclonic dirt cup. Within these three general types a manufacturer may offer different design permutations, for example, a cyclonic dirt cup may include a single cyclonic separation chamber or it may include a primary cyclonic separation chamber and multiple, parallel secondary cyclonic separation chambers.

The upright vacuum cleaners may also include a multitude of other alternative operating features. Such features include, but are not limited to, different numbers of agitators, different agitator widths, an agitator driven by a dedicated drive motor, an agitator driven by a power takeoff from the motor of the suction generator, drive motors of different power ratings, units operated strictly through a power cord received in a standard electrical outlet, battery driven units, hybrid units driven by battery and through a standard electrical outlet, units with different height adjustment mechanisms, self propelled and non-self propelled units, and units with different intelligence systems relating to sensor monitoring and control systems.

Production costs rise when the various floor care appliance models include their own tooling and do not share parts. The present invention relates to a model line of floor care appliances and a method of providing a product line of floor care appliance models that provide for a reduction in production and tooling costs. This is accomplished by providing a universal framework that receives, holds and pivotally connects various mechanical housings with various nozzle assemblies where those mechanical housings and nozzle assemblies include different combinations of operating features.

### SUMMARY OF THE INVENTION

In accordance with the purposes of the present invention as described herein, a floor care appliance is provided comprising a nozzle assembly including a suction inlet, a mechanical housing including a control handle, a dirt collection vessel held in the mechanical housing, a suction generator held in one of the nozzle assembly and the mechanical housing and a universal framework. The universal framework receives and holds the mechanical housing and pivotally connects the mechanical housing and the nozzle assembly.

More specifically, the framework includes a first support and a second support. The mechanical housing is secured between the first and second supports. The framework further includes a first bracket and a second bracket. The first and second brackets are secured to the nozzle assembly. The first support is pivotally connected to the first bracket while the second support is pivotally connected to the second bracket. In addition a first wheel is secured to the first bracket while a second wheel is connected to the second bracket. These wheels allow the floor care appliance to be manipulated smoothly by the operator back and forth across the floor during cleaning. The first and second supports as well as the first and second brackets may all take the form of lattice frameworks if desired.

The dirt collection vessel of the floor care appliance may take any one of a number of forms. In one possible embodiment the dirt collection vessel is a simple dirt cup. In another possible embodiment the dirt collection vessel is a cyclonic dirt cup. In yet another possible embodiment the dirt collection vessel is a filter bag. Further, the nozzle assembly may include one or more rotary agitators.

In accordance with yet another aspect of the present invention a model line of floor care appliances is provided. The model line comprises a first nozzle assembly, a second nozzle assembly different in design from first nozzle assembly, a first mechanical housing including a first suction generator and a first dirt collection vessel and a second mechanical housing including a second suction generator and a second dirt collection vessel. In addition, the model line of floor care appliances includes a universal framework for holding and pivotally connecting (a) either one of first said first and second nozzle assemblies with (b) either one of the first and second mechanical housings.

In one possible embodiment the first nozzle assembly includes a single rotary agitator and the second nozzle assembly includes two rotary agitators. In another possible embodiment the first nozzle assembly includes a first rotary agitator having a width W₁ and the second nozzle assembly includes a second rotary agitator having a width W₂ where W₁<W₂.

In yet another possible embodiment the first nozzle assembly includes a first rotary agitator powered by a dedicated agitator drive motor and the second nozzle assembly includes a second rotary agitator powered by a drive motor of said second suction generator through a power takeoff.

In yet another possible embodiment the first mechanical housing carries a dirt cup and the second mechanical housing carries a filter bag. In still another possible embodiment the first mechanical housing carries a cyclonic dirt cup and the second mechanical housing carries a filter bag. In yet another permutation, the first mechanical housing carries a dirt cup and the second mechanical housing carries a cyclonic dirt cup. In still yet another possible embodiment the first mechanical housing includes a first drive motor and the second mechanical housing includes a second drive motor wherein the first drive motor is more powerful than the second drive motor.

In accordance with yet another aspect of the present invention a method is provided of providing a product line of floor care appliance models while reducing production and tooling costs. The method includes the step of producing a number of different nozzle assemblies, where each different nozzle assembly includes a different combination of operating features. The method further includes producing a number of different mechanical housings wherein each different mechanical housing includes a different combination of operating features. In addition the method includes the step of producing a universal framework for holding and pivotally connecting any one of the different nozzle assemblies with any one of the different mechanical housings. Further, the method includes the step of assembling any one of the different nozzle assemblies with any one of the different mechanical housings using the universal framework to produce a particular floor care appliance model.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIGS. 1a and 1b are respective front and rear perspective views of a floor care appliance constructed in accordance with the teachings of the present invention;

FIG. 2 is an exploded perspective view of the floor care appliance illustrated in FIGS. 1a and 1b;

FIG. 3 is a detailed perspective view illustrating the interconnection of the first wheel with the first support and first bracket of the universal framework of the floor care appliance;

FIG. 4a is a detailed perspective view of a support of the universal framework;

FIG. 4b is a detailed perspective view of a bracket of the universal framework of the present invention; and

FIG. 5 is a schematical illustration of the model line of floor care appliances of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

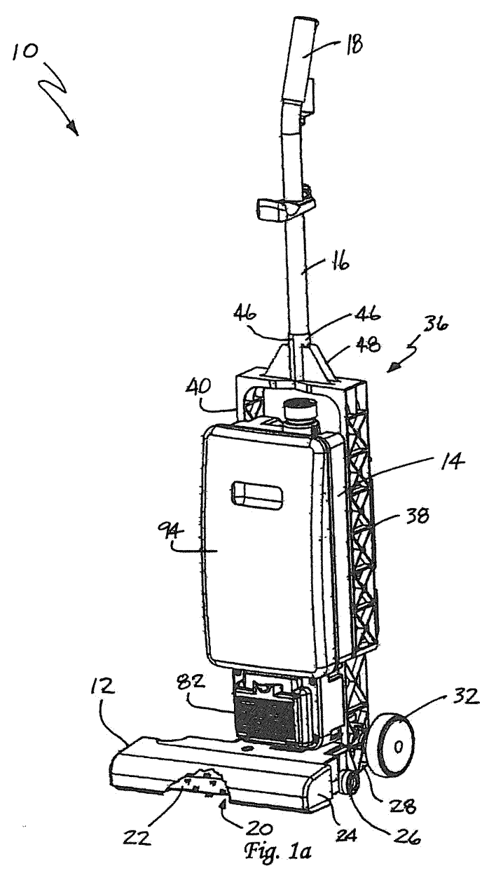

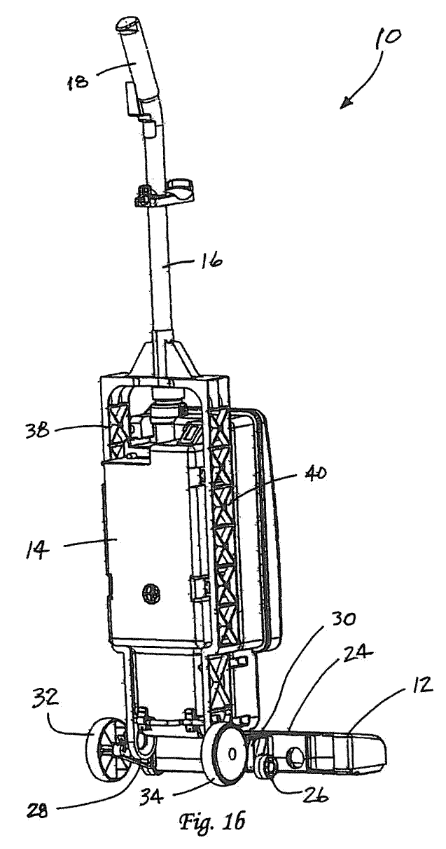

Reference is now made to Figures la and lb illustrating the floor care appliance 10 of the present invention. As illustrated, the floor care appliance 10 takes the form of an upright vacuum cleaner. It should be appreciated, however, that the floor care appliance 10 could also assume the form of an extractor. As generally illustrated in FIGS. 1a and 1b, the floor care appliance 10 includes a nozzle assembly 12 and a mechanical housing 14 pivotally connected to the nozzle assembly. The mechanical housing includes a control handle or stalk 16 equipped with a hand grip 18 for the convenience of the operator. The nozzle assembly 12 includes a suction inlet 20 and a rotary agitator 22.

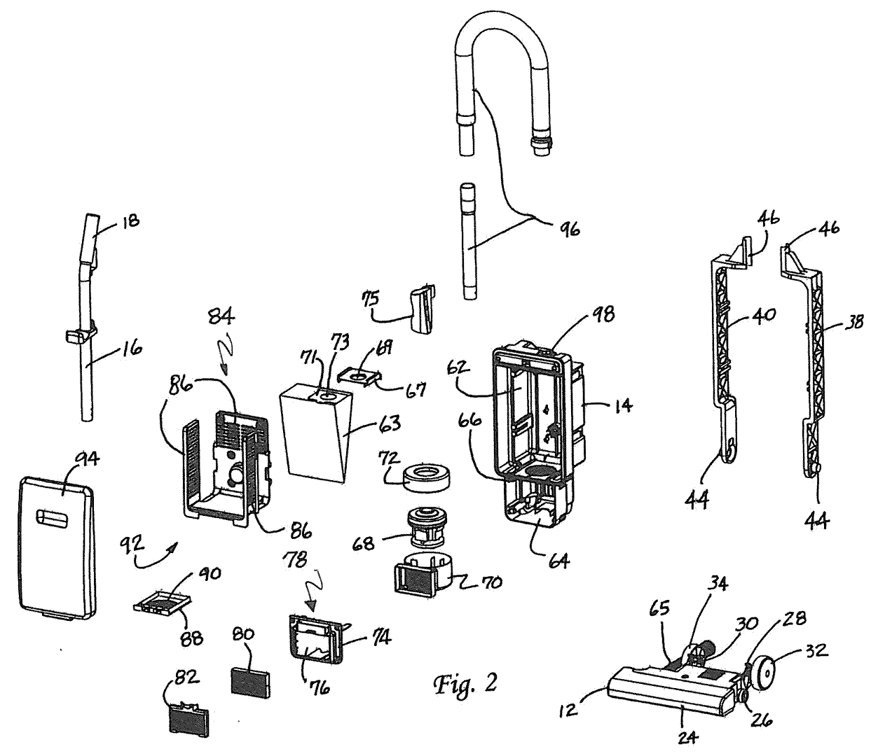

More specifically, the nozzle assembly 12 includes an outer housing 24 that carries a pair of front wheels 26 that allow for height adjustment of the nozzle assembly 12 in order to accommodate the different pile heights characteristic of the carpet being cleaned with the floor care appliance 10. A first bracket 28 and a second bracket 30 are connected to the outer housing 24. A first rear wheel 32 is rotatably mounted to the first bracket 28 while a second rear wheel 34 is rotatably mounted to the second bracket 30 (see also FIG. 2).

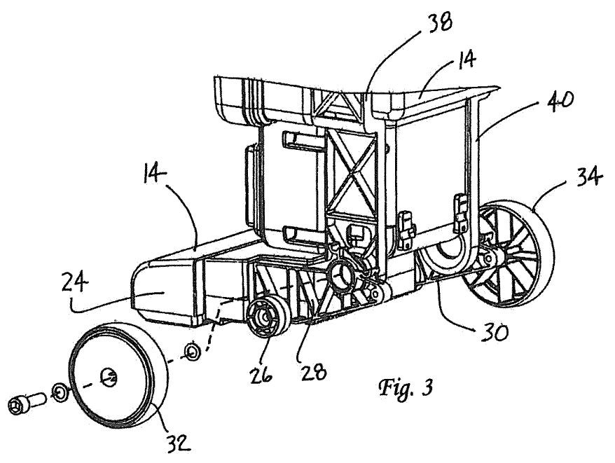

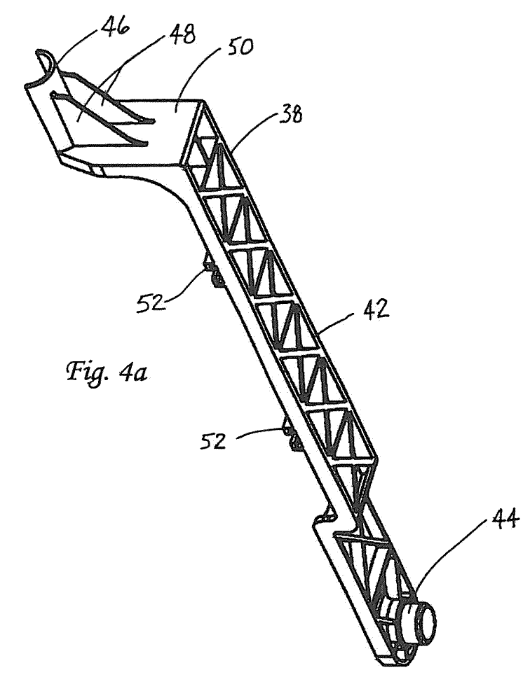

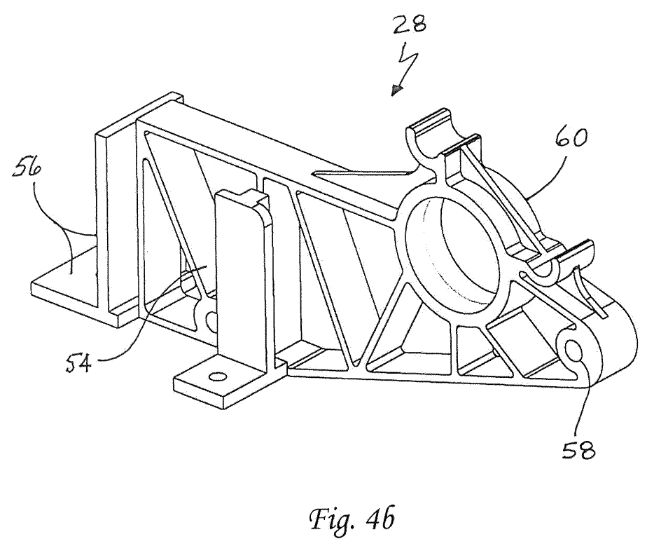

A universal framework, generally designated by reference numeral 36, receives and holds the mechanical housing 14 and pivotally connects the mechanical housing to the nozzle assembly 12. The universal framework 36 comprises the first and second brackets 28, 30 as well as a first support 38 and a second support 40. In the illustrated embodiment, the first and second brackets 28, 30 and first and second supports 38, 40 comprise lattice frameworks (see also FIGS. 3, 4a and 4b). As best illustrated in FIG. 4a, the support 38 comprises an elongated lattice framework 42 having a trunion 44 at one end and a control handle mount 46 at the other end. Gussetts 48 extending between the control handle mount 46 and a top face plate 50 function to reinforce the control handle mount. Integral brackets 52 provided along the elongated lattice framework 42 receive fasteners (not shown) to secure the mechanical housing 14 to the support 38. Here, it should be appreciated that the second support 40 is identical to the first support 38 thereby minimizing the number of parts and consequently reducing production costs.

As should be appreciated from reviewing FIG. 4b, the first bracket 28 comprises a framework body 54 having a nozzle assembly mount 56 at one end and a wheel mount 58 at the opposite end. The bracket 28 further includes an aperture 60 which receives the trunion 44 of the first support 38. Here it should be appreciated that the second bracket 30 is identical to the first bracket 28 and therefore includes an aperture 60 for receiving the trunion 44 of the second support 40. Together, the trunions 44 function to provide the pivotal connection between the mechanical housing 14 and the nozzle assembly 12.

As best illustrated in FIG. 2, the mechanical housing 14 includes a filter bag compartment 62 and a suction generator compartment 64 interconnected by means of an air passageway 66. A suction generator 68, comprising a motor and fan assembly, is received in a motor sound shield 70. An annular dampener 72 is received over the suction generator 68 and functions to attenuate noise and vibration. The motor shield 70, holding the motor 68 and annular dampener 72, is received and held in the suction generator compartment 62. The front of the suction generator compartment 64 is closed by the facing 74. Facing 74 includes an opening 76 through which the operator may access the filter holder 78 on the front of the motor sound shield 70. An air filter 80 is held in the filter holder 78 by decorative cover/exhaust vent which closes the facing 74 and captures the air filter 80 in the filter holder 78.

An air flow system 84 including a series of vents 86 is received in the filter bag compartment 62 and provides clean, open pathways for air to reach the air pathway 66 leading to the suction generator compartment 64. An air filter drawer 88, received in the air flow system 84, holds a replaceable filter 90 that overlies the pathway 66. A filter bag 63 is received in the cavity 92 of the air flow system 84 in the filter bag compartment 62. A removable cover 94 provides access to the filter bag 63 in the filter bag compartment 62 in a manner known in the art. A nozzle hose 65 and an air hose and wand assembly 96 are part of the conduit system that directs air from the suction inlet 20 of the nozzle assembly 12 to the inlet port 98 of the filter bag compartment 62.

A bag holder 67, including an airway aperture 69, is secured in the compartment 62 over the inlet port 98 The mounting plate 71 on the filter bag 63 is received and held by the bag holder 67 so that the opening 73 therein is aligned with the airway aperture 69 and the inlet port 98.

The control handle 16 is secured in the control handle mounts 46 of the two supports 38, 40 by means of cooperating screw fasteners 100. A wand holder 75 is secured to the housing 14. The wand holder 75 holds the wand of the air hose and wand assembly 96 during normal upright vacuum cleaner operation.

In operation, dirt and debris are beaten from a carpet being cleaned by the rotary agitator 22. That dirt and debris is then swept into the suction inlet 20 by the negative air pressure generate by the suction generator 68. The dirt and debris travels through the nozzle hose 65, the wand holder 75 and the air hose and wand assembly 96 before being discharged through the inlet port 98, the airway aperture 69 in the bag holder 67 and the opening 73 in the mounting plate 71 into the filter bag 63. Dirt and debris is captured in the filter bag 63 while the relatively clean air is drawn through the pores in the filter bag into the air flow system 86. From there the air stream is directed through the filter 90 in the filter drawer 88 and then through the air passageway 66 and into the suction generator compartment 64. The air stream is then drawn over the motor of the suction generator 68 before being exhausted through the final filter 80 and returned to the environment through the cover exhaust vent 82.

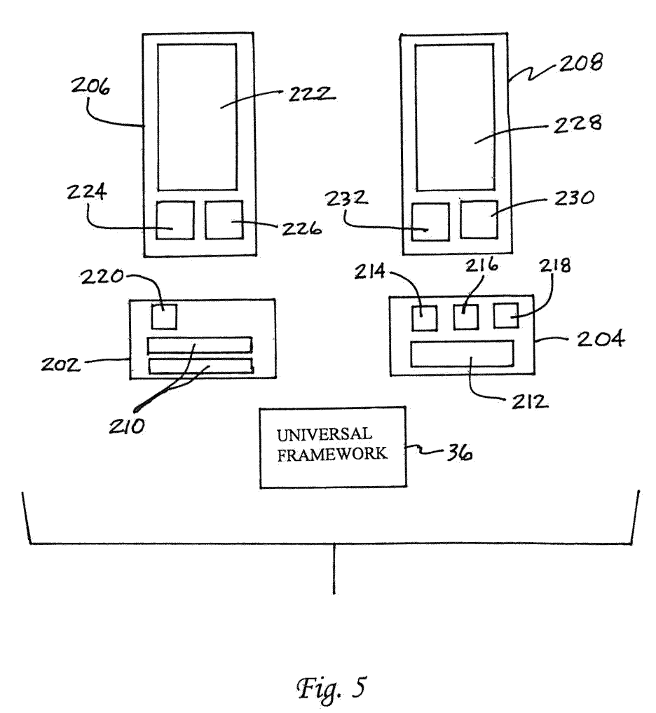

Significantly, it should be appreciated that the universal framework 35 of the present invention may be used to selectively hold and pivotally connect nozzle assemblies of different design with mechanical housings of different designs in order to construct a complete model line of floor care appliances with maximum flexibility and versatility at minimal cost. This is best illustrated in FIG. 5.

As best illustrated schematically in FIG. 5, the model line of floor care appliances 200 may include a first nozzle assembly 202, a second nozzle assembly 204, a first mechanical housing 206, a second mechanical housing 208 and the universal framework 36 described above. As illustrated, the first nozzle assembly 202 includes multiple rotary agitators 210. Each of the agitators 210 has a width W₁. In contrast, the second nozzle assembly 204 includes a single rotary agitator 212 having a width W₂ where W₁<W₂. The second nozzle assembly 204 also includes a dedicated drive motor 214 for driving the rotary agitator 212. The second nozzle assembly 204 may also include an optional self propulsion motor 216 for assisting the operator in moving the floor care appliance back and forth across the floor during the cleaning operation. Still further, the second nozzle assembly 204 may include a five position height adjustment mechanism 218 which may be manual or motor driven. This differs from the first nozzle assembly 202 which does not have to include a height adjustment mechanism or may optionally include a height adjustment mechanism 220 different from that provided on the second nozzle assembly 204 (e.g. a three position height adjustment mechanism).

The first mechanical housing 206 may include a filter bag 222, a sensor and display system 224 for detecting and indicating when the filter bag is full and a suction generator 226 incorporating a drive motor with power output P₁.

In contrast, the second mechanical housing 208 includes a dirt collection vessel in the form of a dirt cup 228. Dirt cup 228 may be of the non-cyclonic or cyclonic type. Examples of such dirt cups may be found in, for example, published U.S. Patent Application No. 2007/0067944 and co-pending U.S. application Ser. Nos. 12/365,434 filed on 4 Feb. 2009, 12/368,524 filed on 10 Feb. 2009 and 12/428,880 filed on 23 Apr. 2009, the full disclosures of which are incorporated herein by reference. In addition, the second mechanical housing 208 may include a sensor and display system 230 different from the sensor and display system 224 provided on the first mechanical housing 206. Thus, for example, the sensor and display system 230 may comprise a dirt sensor and indicator providing the operator with notice when the vacuum appliance is no longer picking up dirt and debris from the area of carpet being cleaned. Further, the second mechanical housing 208 includes a suction generator 232 equipped with a drive motor having a power output P₂ where P₁>P₂.

It should be appreciated that the universal framework 36 allows any of the different nozzle assemblies 202, 204 to be operably connected with any of the mechanical housings 206, 208. Thus, the first nozzle assembly 202 may be interconnected with the first mechanical housing 206 to provide a first floor care appliance model. Similarly, the first nozzle assembly 202 may be connected with the universal assembly 36 to the second mechanical housing 208 to provide a second floor care appliance model. Still further, the second nozzle assembly 204 may be interconnected with the universal framework 36 to the first mechanical housing 206 to provide a third model while the second nozzle assembly 204 may alternatively, be interconnected with the universal framework 36 to the second mechanical housing 208 to provide a fourth model of floor care appliance 10. Thus, it should be appreciated that two different nozzle assemblies 202, 204 may be interconnected with the universal framework 36 to two different mechanical housing 206, 208 to provide a four model product line. Since the same universal framework 36 is utilized to interconnect all of the different models, tooling costs are minimized, production efficiencies are increased and production costs are significantly reduced.

This allows the manufacturer to offer a product line with a wider range of mixed and matched features that appeals to a broader segment of the potential customer base thereby providing the manufacturer with the opportunity to enhance customer satisfaction and increase market share. While the illustrated example refers to two different nozzle assemblies 202, 204 and two different mechanical housings 206, 208, it should be appreciated that substantially any number of different nozzle assemblies and any number of different mechanical housings may be interconnected with the universal framework 36 to provide a product line with models offering a virtually infinite number of performance feature combinations. Accordingly, the present invention represents a significant advance in the art.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A floor care appliance, comprising:
a nozzle assembly including a suction inlet;
a mechanical housing including a control handle;
a dirt collection vessel held in said mechanical housing;
a suction generator held in one of said nozzle assembly and said mechanical housing;
a universal framework receiving and holding said mechanical housing and pivotally connecting said mechanical housing and said nozzle assembly.

2. The floor care appliance of claim 1, wherein said framework includes a first support and a second support and said mechanical housing is secured between said first and second supports.

3. The floor care appliance of claim 2, wherein said framework further includes a first bracket and a second bracket wherein said first and second brackets are secured to said nozzle assembly.

4. The floor care appliance of claim 3, wherein said first support is pivotally connected to said first bracket and said second support is pivotally connected to said second bracket.

5. The floor care appliance of claim 4, further including a first wheel secured to said first bracket and a second wheel secured to said second bracket.

6. The floor care appliance of claim 5, wherein said first support and said second support are lattice frameworks.

7. The floor care appliance of claim 6, wherein said first bracket and said second bracket are lattice frameworks.

8. The floor care appliance of claim 1, wherein said dirt collection vessel is a dirt cup.

9. The floor care appliance of claim 1, wherein said dirt collection vessel is a cyclonic dirt cup.

10. The floor care appliance of claim 1, wherein said dirt collection vessel is a filter bag.

11. The floor care appliance of claim 1, wherein said nozzle assembly includes a rotary agitator.

12. A model line of floor care appliances, comprising:
a first nozzle assembly;
a second nozzle assembly different in design from said first nozzle assembly;
a first mechanical housing including a first suction generator and a first dirt collection vessel;
a second mechanical housing including a second suction generator and a second dirt collection vessel;
a universal framework for holding and pivotally connecting (a) either one of said first and second nozzle assemblies with (b) either one of said first and second mechanical housings.

13. The model line of floor care appliances of claim 12, wherein said first nozzle assembly includes a single rotary agitator and said second nozzle assembly includes two rotary agitators.

14. The model line of floor care appliances of claim 12, wherein said first nozzle assembly includes a first rotary agitator having a width W1 and said second nozzle assembly includes a second rotary agitator having a width W2 where W1<W2.

15. The model line of floor care appliances of claim 12, wherein said first nozzle assembly includes a first rotary agitator powered by a dedicated agitator drive motor and said second nozzle assembly includes a second rotary agitator powered by a drive motor of said second suction generator through a power take off.

16. The model line of floor care appliances of claim 12, wherein said first mechanical housing carries a dirt cup and said second mechanical housing carries a filter bag.

17. The model line of floor care appliances of claim 12, wherein said first mechanical housing carries a cyclonic dirt cup and said second mechanical housing carries a filter bag.

18. The model line of floor care appliances of claim 12, wherein said first mechanical housing carries a dirt cup and said second mechanical housing carries a cyclonic dirt cup.

19. The model line of floor care appliances of claim 12, wherein said first mechanical housing includes a first drive motor and said second mechanical housing includes a second drive motor wherein said first drive motor is more powerful than said second drive motor.

20. A method of providing a product line of floor care appliance models while reducing production and tooling costs, comprising:
producing a number of different nozzle assemblies, each said different nozzle assembly including a different combination of operating features;
producing a number of different mechanical housings, each said different mechanical housing including a different combination of operating features;
producing a universal framework for holding and pivotally connecting any one of said different nozzle assemblies with anyone of said different mechanical housings; and
assembling any one of said different nozzle assemblies with anyone of said different mechanical housings using said universal framework to produce a particular floor care appliance model.
